(19) United States
(12) Patent Application Publication
(10) Pub. No.: US 2011/0051128 A1
(43) Pub. Date: Mar. 3, 2011

(54) Semiconductor Device and Electronics Equipped Therewith

(75) Inventor: Masao Horibe, Kyoto (JP)

(73) Assignee: Rohm Co., Ltd., Kyoto (JP)

(21) Appl. No.: 12/811,110

(22) PCT Filed: Jan. 25, 2010
(86) PCT No.: PCT/JP2010/050895

§ 371 Date: Jun. 29, 2010

(30) Foreign Application Priority Data
Jan. 26, 2009 (JP) 2009-014222

(51) Int. Cl. G01J 1/42

(52) U.S. Cl. 356/218

(57) ABSTRACT

A semiconductor device (101) includes: a table unit (11) for receiving photodetection data indicating intensity of light, and outputting current data indicating a current value corresponding to a value of the photodetection data, the table unit having an association between the photodetection data and the current data stored therein in a fixed manner; a current adjustment unit (12) for adjusting the current value indicated by the current data in accordance with a variable parameter, and outputting adjusted current data indicating the current value adjusted; and a current supply unit (4) for supplying a load (53) with a current based on the adjusted current data.

### TECHNICAL FIELD

The present invention relates generally to a semiconductor device and electronics equipped therewith and particularly to a semiconductor device supplying a load with a current based on intensity of incident light and electronics equipped therewith.

### BACKGROUND ART

Mobile phones, liquid crystal television sets and similar electronics for example employ a light emitting diode (LED) device as a back light for a liquid crystal display (LCD).

An LED is driven by a technique configured for example as disclosed in Japanese Patent Laying-open No. 2008-227325 (Patent Document 1), as follows: More specifically, a light emitting diode driving device includes: a drive voltage generation unit generating a drive voltage applied to a light emitting diode at the anode; a drive current control unit controlling pulse width modulation of a drive current flowing through the light emitting diode; and a monitor voltage generation unit monitoring the drive voltage and generating a monitor voltage having a variation of the drive voltage that is caused while the drive current is off, superimposed thereon with reference to a predetermined reference voltage while the drive current is off, and while the drive current is on, the drive voltage generation unit controls the drive voltage in a feedback manner so that a feedback voltage drawn from the light emitting diode at the cathode matches the reference voltage, and while the drive current is off, the drive voltage generation unit controls the drive voltage in a feedback manner so that the monitor voltage matches the reference voltage.

### PRIOR ART DOCUMENTS

### Patent Documents

Patent Document 1: Japanese Patent Laying-open No. 2008-227325

### SUMMARY OF THE INVENTION

### Problems to be Solved by the Invention

Such electronics conventionally include for example an illuminance sensor or a similar photodetection element, and a current passing therethrough is converted by a resistive element to voltage which is in turn converted by an analog to digital (AD) converter to a digital signal, and based on the digital signal, an LED device is supplied with a current.

In such a configuration, a table used to convert an intensity of light indicated by the digital signal to a value of a current supplied to the LED device needs an amount of data corresponding to the number of bits of the digital signal multiplied by that of bits of the data indicating the value of the current supplied to the LED device, resulting in an increased circuit scale.

Patent Document 1, however, does not disclose a configuration for solving such a problem.

The present invention therefore contemplates a semiconductor device that can miniaturize a circuit supplying a load with a current based on intensity of light, and also converting intensity of light to a current value, and electronics equipped with the semiconductor device.

### Means for Solving the Problems

To address the above issue, the present invention in one aspect provides a semiconductor device including: a table unit for receiving photodetection data indicating an intensity of light, and outputting current data indicating a current value corresponding to a value of the photodetection data, the table unit having an association between the photodetection data and the current data stored therein in a fixed manner; a current adjustment unit for adjusting the current value indicated by the current data in accordance with a variable parameter, and outputting adjusted current data indicating the current value adjusted; and a current supply unit for supplying a load with a current based on the adjusted current data.

Preferably, the current adjustment unit adjusts the current value indicated by the current data in accordance with first to third variable parameters, and outputs the adjusted current data indicating the current value adjusted, the first parameter indicates a value for multiplying the current value indicated by the current data, the second parameter indicates a minimum value of the current to be supplied to the load, the third parameter indicates a maximum value of the current to be supplied to the load, and the current adjustment unit outputs the adjusted current data indicating a product of the current value indicated by the current data and the value indicated by the first parameter plus the minimum value indicated by the second parameter, and if the adjusted current data indicates a current value larger than the maximum value indicated by the third parameter, the current adjustment unit outputs adjusted current data indicating the maximum value.

More preferably, the table unit has a plurality of types of associations between the photodetection data and the current data stored therein in a fixed manner, the parameter indicates what type of association the photodetection data and the current data have therebetween, and the table unit outputs the current data indicating the current value corresponding to the value of the photodetection data in accordance with the parameter.

Preferably, the parameter indicates a value for multiplying the current value indicated by the current data, and the current adjustment unit outputs adjusted current data indicating a product of the current value indicated by the current data and the value indicated by the parameter.

Preferably, the parameter indicates a minimum value of the current to be supplied to the load, and the current adjustment unit outputs adjusted current data indicating a sum of the current value indicated by the current data and the minimum value indicated by the parameter.

Preferably, the parameter indicates a maximum value of the current to be supplied to the load, and if the current data indicates a current value larger than the maximum value indicated by the parameter, the current adjustment unit outputs adjusted current data indicating the maximum value.

Preferably, the table unit has a plurality of types of associations between the photodetection data and the current data stored therein in a fixed manner, the parameter indicates what type of association the photodetection data and the current data have therebetween, and the table unit outputs the current data indicating the current value corresponding to the value of the photodetection data in accordance with the parameter.

Preferably, the semiconductor device further includes: a register for storing the photodetection data and the parameter; and a signal input/output circuit for externally outputting the photodetection data stored in the register, and for externally receiving the parameter and providing the parameter to the register.

Preferably, the semiconductor device further includes: a voltage generation circuit for supplying an external photosensor with power supply voltage; and a data generation unit for generating the photodetection data in accordance with a current output from the photosensor.

Preferably, the semiconductor device further includes a gain control unit for controlling a gain of the photosensor in accordance with the photodetection data, wherein the data generation unit generates the photodetection data in accordance with the gain of the photosensor and the current output from the photosensor.

Preferably, the voltage generation circuit, the data generation unit and the gain control unit operate in a predetermined cycle intermittently.

Preferably, the semiconductor device further includes: an A/D converter for converting an analog voltage indicating an intensity of light to a digital signal in a predetermined first cycle; and an averaging unit for averaging a plurality of digital signals generated in the A/D converter to generate the photodetection data.

Preferably, the A/D converter operates in a second cycle intermittently to generate the plurality of digital signals in each operation period, the second cycle being longer than the first cycle, and the averaging unit averages the plurality of digital signals to generate the photodetection data whenever the A/D converter generates the plurality of digital signals.

Preferably, when the adjusted current data indicates that the current value adjusted has transitioned from a first current value to a second current value, the current supply unit gradually varies the current to be supplied to the load from the first current value to the second current value.

Preferably, a rate used to vary a value of the current to be supplied to the load is settable to a desired value.

Preferably, the current supply unit supplies the load with the current in accordance with the adjusted current data when a PWM signal has a first logic level, and the current supply unit stops supplying the load with the current when the PWM signal has a second logic level,

To address the above issue, the present invention in another aspect provides electronics including: a photosensor for outputting a current corresponding to an intensity of light incident thereon; a light emitting element; a data generation unit for outputting photodetection data based on the current output from the photosensor, and indicating the intensity of light incident on the photosensor; a table unit for receiving the photodetection data and outputting current data indicating a current value corresponding to a value of the photodetection data, the table unit having an association between the photodetection data and the current data stored therein in a fixed manner; a current adjustment unit for adjusting the current value indicated by the current data in accordance with a variable parameter, and outputting adjusted current data indicating the current value adjusted; and a current supply unit for supplying the light emitting element with a current based on the adjusted current data.

### Effects of the Invention

The present invention can thus miniaturize a circuit supplying a load with a current based on intensity of light, and also converting intensity of light to a current value.

### BRIEF DESCRIPTION OF THE DRAWINGS

FIG. 1 is a circuit block diagram showing a configuration of electronics according to a first embodiment of the present invention.

FIG. 2 shows a conversion operation performed by a table unit in a semiconductor device shown in FIG. 1.

FIG. 3 shows a multiplier parameter used by a current adjustment unit in the FIG. 1 semiconductor device.

FIG. 4 is a graph representing a load current value I calculated by a load current calculation unit in the FIG. 1 semiconductor device for a curve setting parameter CRV=0.

FIG. 5 is a graph representing load current value I calculated by the load current calculation unit of FIG. 1 for a curve setting parameter CRV=1.

FIG. 6 is a circuit block diagram of a major portion of a mobile phone according to a second embodiment of the present invention.

FIG. 7 is a circuit block diagram of a photosensor shown in FIG. 6.

FIG. 8 is a diagram representing how the photosensor shown in FIG. 7 operates.

FIG. 9 is another diagram representing how the photosensor shown in FIG. 7 operates.

FIG. 10 is a circuit block diagram showing the second embodiment in an exemplary variation.

FIG. 11 is a circuit block diagram showing the second embodiment in another exemplary variation.

FIG. 12 represents how an averaging/brightness determination unit shown in FIG. 6 operates.

FIG. 13 is timing plots representing how a portion of the FIG. 6 mobile phone that is associated with illuminance measurement operates.

FIG. 14 is a timing plot representing how a sloping unit shown in FIG. 6 operates.

FIG. 15 is another timing plot representing how the sloping unit shown in FIG. 6 operates.

FIG. 16 is still another timing plot representing how the sloping unit shown in FIG. 6 operates. FIG. 17 represents how a register shown in FIG. 6 operates.

FIG. 18 is a flowchart of a method of turning on a backlight (LED) in an automatic light adjustment mode.

FIG. 19 is a flowchart of a method of turning on and off the backlight (LED) in a register setting mode.

### MODES FOR CARRYING OUT THE INVENTION

### First Embodiment

Hereinafter the present invention in a first embodiment will be described with reference to the drawings. In the figures, identical or like components are identically denoted and will not be described repeatedly.

[Configuration and Basic Operation]

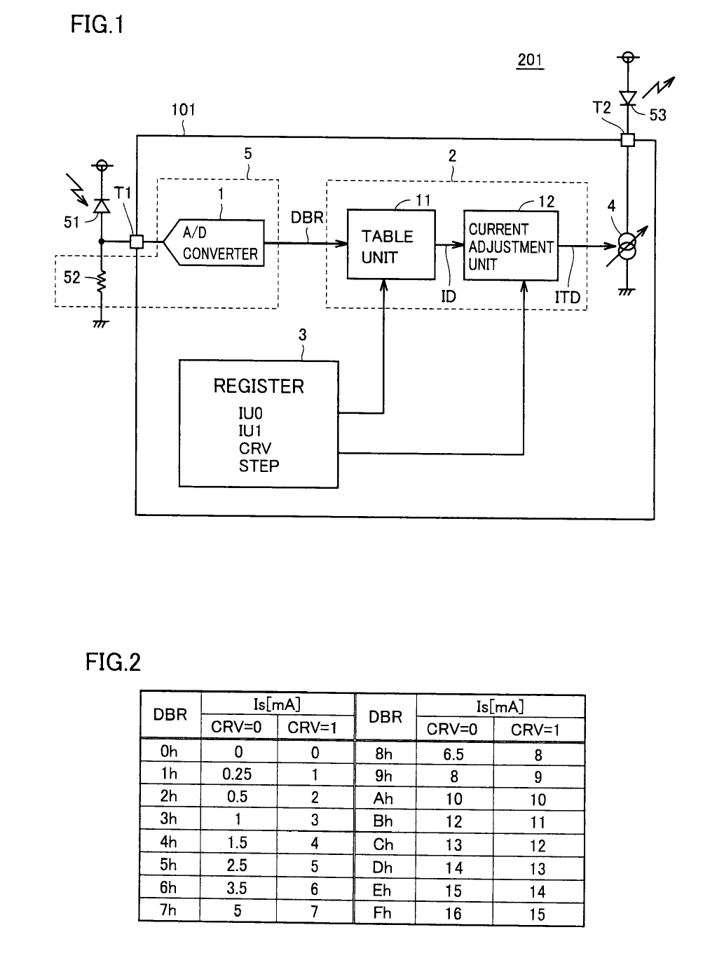

FIG. 1 is a diagram showing a configuration of electronics according to the first embodiment of the present invention.

With reference to FIG. 1, electronics 201 includes a photodetection element 51, a resistive element 52, a load 53, and a semiconductor device 101. Semiconductor device 101 includes an analog to digital (A/D) converter 1, a load current calculation unit 2, a register 3, a variable constant current source 4, and terminals T1, T2. Load current calculation unit 2 includes a table unit 11 and a current adjustment unit 12. A/D converter 1 and resistive element 52 configure a data generation unit 5.

Photodetection element 51 is for example a photodiode, and when light is incident thereon, it outputs a current corresponding to the incident light's intensity (or quantity of light).

Data generation unit 5 receives the current output from photodetection element 51 and outputs photodetection data DBR based on the current and indicating the intensity of the light incident on photodetection element 51. More specifically, resistive element 52 receives the current output from photodetection element 51 and converts the received current to a voltage. The voltage is supplied to semiconductor device 101 at terminal T1. A/D converter 1 receives the voltage, which is in the form of an analog signal, through terminal T1, converts the analog signal of the voltage to a digital signal of photodetection data DBR, and outputs photodetection data DBR to load current calculation unit 2.

Load current calculation unit 2 calculates a load current value I based on photodetection data DBR received from data generation unit 5.

More specifically, table unit 11 receives photodetection data DBR from A/D converter 1 and outputs current data ID indicating a current value corresponding to the value of photodetection data DBR. Table unit 11 has a plurality of types of associations between photodetection data DBR and current data ID stored therein in a fixed manner.

Current adjustment unit 12 receives current data ID indicating a current value, adjusts the current value, based on a plurality of parameters which are variable externally of semiconductor device 101, and outputs adjusted current data ITD indicating the adjusted current value.

Variable constant current source 4 supplies load 53 with a current based on adjusted current data ITD. Load 53 is for example an LED or a similar light emitting device, and emits light based on a load current supplied from variable constant current source 4 through terminal T2.

[Operation]

In the present invention according to the first embodiment the semiconductor device in calculating a load current value operates, as will be described hereinafter.

Load current calculation unit 2 calculates load current value I in accordance with the following equation:

I=Is×k+IU0

Furthermore, load current calculation unit 2 provides I=IU1 for I>IU1.

Note that Is represents an initial load current value calculated by table unit 11, k represents a load current adjusting coefficient, IU0 represents a minimum value of a current to be supplied to load 53, and IU1 represents a maximum value of the current to be supplied to load 53.

FIG. 2 shows a conversion operation performed by the table unit in the semiconductor device according to the first embodiment of the present invention.

With reference to FIG. 2, table unit 11 receives photodetection data DBR from A/D converter 1, and converts photodetection data DBR to initial load current value Is, as shown in the FIG. 2 table. Table unit 11 outputs to current adjustment unit 12 current data ID indicating initial load current value Is corresponding to the value of photodetection data DBR.

Table unit 11 has an association between photodetection data DBR and current data ID stored therein in a fixed manner. Furthermore, FIG. 2 shows a curve setting parameter CRV, which indicates types of patterns of converting photodetection data DBR to current data ID by table unit 11, i.e., types of association between photodetection data DBR and current data ID, and is variable externally of semiconductor device 101.

Table unit 11 outputs current data ID based on curve setting parameter CRV and indicating a current value corresponding to the value of photodetection data DBR. More specifically, table unit 11 selects in accordance with curve setting parameter CRV one of a plurality of types of current values that corresponds to the value of photodetection data DBR, and table unit 11 outputs current data ID indicating the selected current value.

For example, when curve setting parameter CRV=0 and photodetection data DBR has a value of 9h, table unit 11 outputs to current adjustment unit 12 current data ID indicating 8 mA, wherein h indicates hexadecimal notation.

When curve setting parameter CRV=1 and photodetection data DBR has a value of Ah, table unit 11 outputs to current adjustment unit 12 current data ID indicating 10 mA.

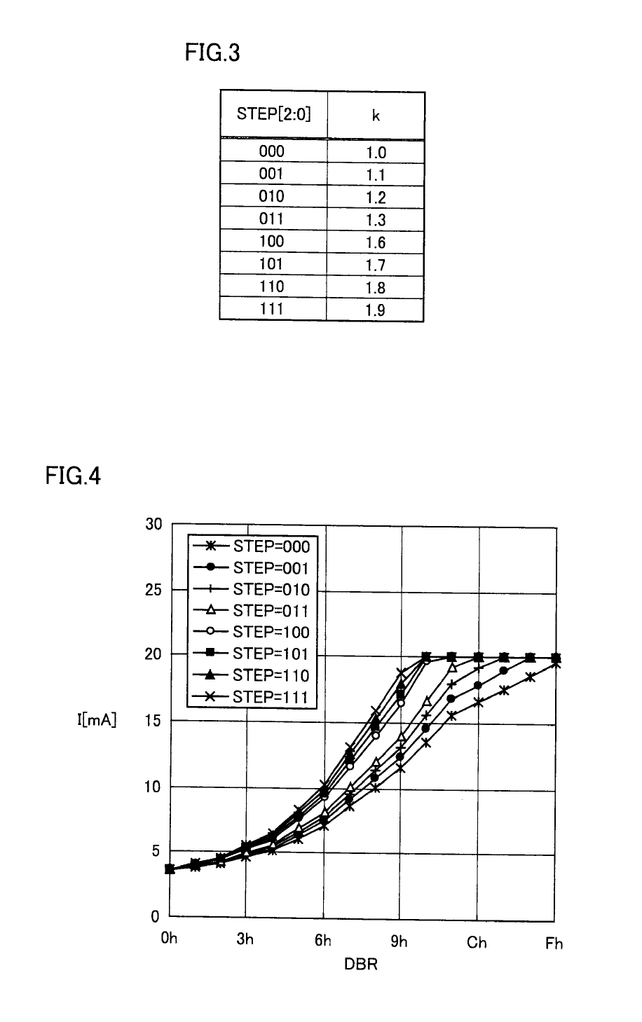

FIG. 3 shows a multiplier parameter used by the current adjustment unit in the semiconductor device according to the first embodiment of the present invention.

With reference to FIG. 3, multiplier parameter STEP is for example 3-bit data, and indicates a load current adjusting coefficient used to multiply initial load current value Is indicated by current data ID. In FIG. 3, multiplier parameter STEP is represented in binary notation.

Current adjustment unit 12 outputs current data ITD indicating a product of a current value indicated by current data ID and a value indicated by multiplier parameter STEP.

For example, for multiplier parameter STEP=100, current adjustment unit 12 multiplies initial load current value Is indicated by current data ID by 1.6.

For multiplier parameter STEP=000, current adjustment unit 12 multiplies initial load current value Is indicated by current data ID by 1.0.

Furthermore, current adjustment unit 12 provides initial load current value Is multiplied, as determined, as based on multiplier parameter STEP, plus minimum load current value IU0 to provide load current value I. Current adjustment unit 12 then outputs adjusted current data IT indicating load current value I to variable constant current source 4.

FIG. 4 is a graph representing load current value I calculated by the load current calculation unit in the semiconductor device according to the first embodiment of the present invention for curve setting parameter CRV=0.

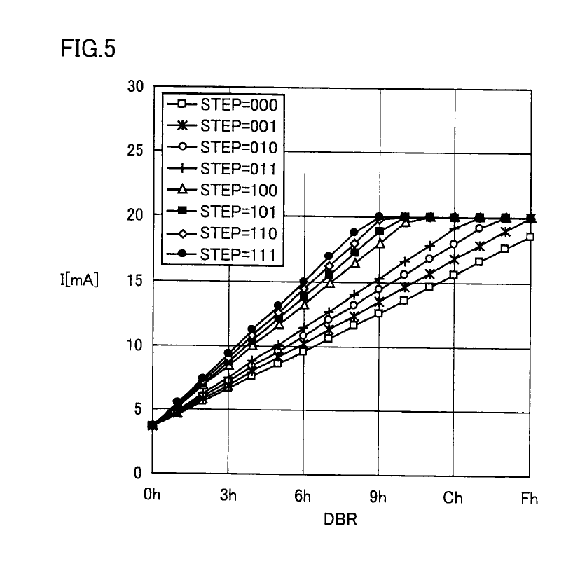

FIG. 5 is a graph representing load current value I calculated by the load current calculation unit in the semiconductor device according to the first embodiment of the present invention for curve setting parameter CRV=1.

FIGS. 4 and 5 show an example with minimum load current value IU0=4 (mA) and maximum load current value IU1=20 (mA).

Current adjustment unit 12 multiplies initial load current value Is by a value indicated by multiplier parameter STEP to provide a product thereof, and adds minimum load current value IU0 to the product.

For example, for photodetection data DBR=9h, curve setting parameter CRV=0, multiplier parameter STEP=100, and minimum load current value IU0=4 (mA), then load current value I=8 (mA)×1.6+4 (mA)=16.8 (mA).

For photodetection data DBR=Ch, curve setting parameter CRV=1, multiplier parameter STEP=100, and minimum load current value IU0=4 (mA), then load current value I=12 (mA)×1.6+4 (mA)=23.2 (mA). As maximum load current value IU1=20 (mA), current adjustment unit 12 clamps load current value I at 20 (mA).

Let us assume that load current calculation unit 2 does not perform such an operation as above, and instead includes a register that can set load current value I for each value of photodetection data DBR. In that case, if adjusted current data IT has seven bits, the types of values that photodetection data DBR can assume, i.e., 16, ×the number of bits of adjusted current data IT, i.e., 7, =112, and a register for 112 bits will thus be required.

In contrast, the present semiconductor device in the first embodiment requires a table having fixed values stored therein for 16×7 bits=112 bits for converting photodetection data DBR to current data ID. Furthermore, if it is assumed that the number of bits of each of data indicating a minimum load current value and data indicating a maximum load current value is equal to that of bits of adjusted current data IT, then there will be required a register for 7 bits for setting minimum load current value IU0, a register for 7 bits for setting maximum load current value IU1, a register for 1 bit for setting curve setting parameter CRV, and a register for 3 bits for setting multiplier parameter STEP, i.e., registers for 18 bits in total.

Note that when a register that can change a value is compared with a table having fixed values stored therein, the register has a much larger circuit scale than the table. In other words, the present invention in the first embodiment provides a semiconductor device that does not require a register for 112 bits and instead only requires a table for 112 bits, and a register for 18 bits, i.e., of a significantly small scale, and can thus contribute to a significantly reduced circuit scale.

### Second Embodiment

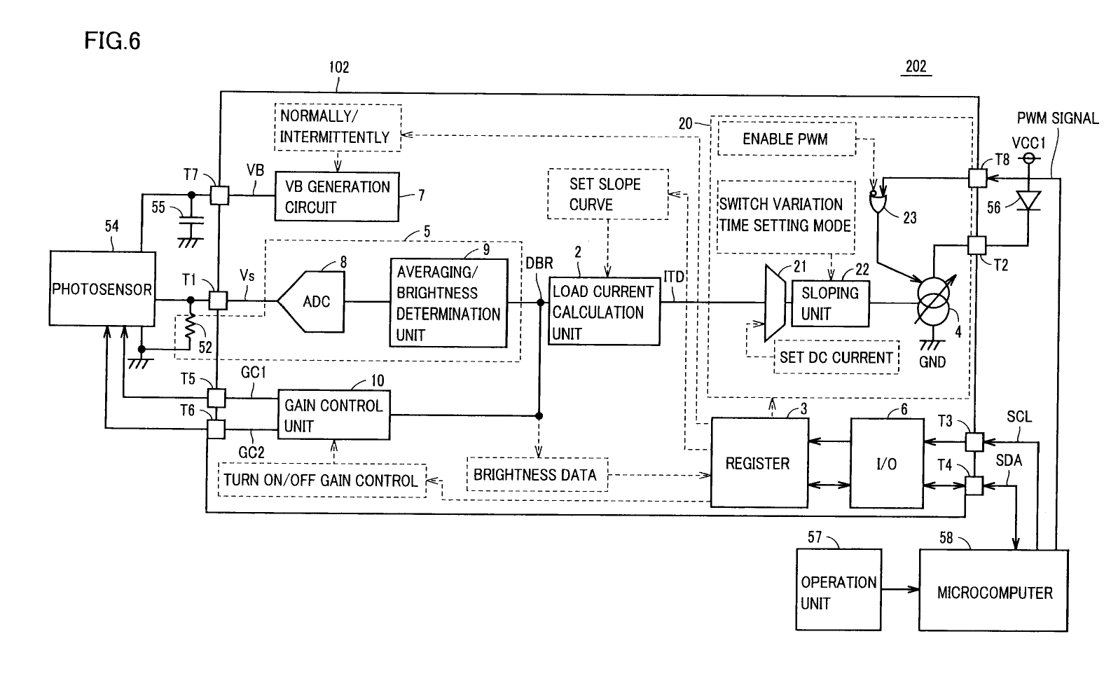

FIG. 6 is a circuit block diagram of a major portion of a mobile phone 202 according to a second embodiment of the present invention. With reference to FIG. 6, mobile phone 202 includes resistive element 52, a photosensor 54, a capacitor 55, an LED 56, an operation unit 57, a microcomputer 58, and a semiconductor device 102. LED 56 is included in a backlight of a liquid crystal display device of mobile phone 202. While in reality the backlight includes a plurality of LEDs 56, the figure shows only one LED 56 for the sake of simplicity.

Operation unit 57 includes a plurality of buttons and/or the like operated by the user of mobile phone 202. Microcomputer 58 is operative in response to a signal received from operation unit 57 to set a variety of types of conditions for semiconductor device 102. Photosensor 54 detects illuminance at a location where mobile phone 202 is used. Semiconductor device 102 operates in accordance with a result of the detection by photosensor 54 to control intensity of light emitted by LED 56. This can enhance in viewability an image displayed on the liquid crystal screen and also contribute to reduced power consumption.

More specifically, semiconductor device 102 includes load current calculation unit 2, register 3, a signal input/output (I/O) circuit 6, a VB generation circuit 7, an A/D converter (ADC) 8, an averaging/brightness determination unit 9, a gain control unit 10, a current supply unit 20, and terminals T1-T8. Resistive element 52, A/D converter 8, and averaging/brightness determination unit 9 configure data generation unit 5.

Register 3 provides load current calculation unit 2 with multiplier parameter STEP, curve setting parameter CRV, minimum load current value IU0 and maximum load current value IU1, as has been indicated in the first embodiment. Register 3 includes a plurality of sub registers. Each sub register is previously assigned a unique address. For example, multiplier parameter STEP and curve setting parameter CRV are stored in a first sub register, minimum load current value IU0 is stored in a second sub register, and maximum load current value IU1 is stored in a third sub register.

Each sub register has its content(s) writably and readably. More specifically, terminal T3 receives a serial clock signal SCL from microcomputer 58. Terminal T4 is used to input and output a serial data signal SDA. Signal I/O circuit 6 is provided between register 3 and terminals T3 and T4, and receives serial clock signal SCL from microcomputer 58 through terminal T3 and transmits the signal to register 3. Furthermore, signal I/O circuit 6 receives serial data signal SDA from microcomputer 58 through terminal T4 and transmits the signal to register 3, and receives serial data signal SDA from register 3 and transmits the signal through terminal T4 to microcomputer 58.

In a write operation, microcomputer 58 provides serial clock signal SCL through terminal T3 and signal I/O circuit 6 to register 3, and in synchronization with serial clock signal SCL provides serial data signal SDA including a write instruction signal, an address signal and information to be written through terminal T4 and signal 110 circuit 6 to register 3. Register 3 writes the information to be written (e.g., multiplier parameter STEP) to a sub register designated therein by the address signal.

In a read operation, microcomputer 58 provides serial clock signal SCL through terminal T3 and signal I/O circuit 6 to register 3, and in synchronization with serial clock signal SCL provides serial data signal SDA including a read instruction signal and an address signal through terminal T4 and signal I/O circuit 6 to register 3. Register 3 operates in synchronization with serial clock signal SCL to read information (e.g., brightness data) from a sub register designated therein by the address signal, and provides the information as serial data signal SDA through signal I/O circuit 6 and terminal T4 to microcomputer 58. Register 3 thus has its contents stored therein writably and readably. Register 3 controls load current calculation unit 2 and others, i.e., generally controls semiconductor device 102, in accordance with the content(s) stored in register 3.

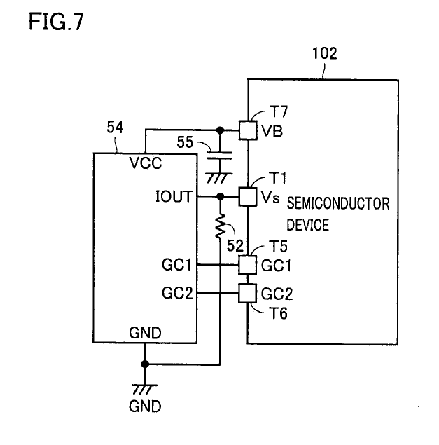

Photosensor 54 is configured as a single IC. As shown in FIG. 7, photosensor 54 has a power supply terminal (VCC), an output terminal (IOUT), a first gain terminal (GC1), and a second gain terminal (GC2) connected to semiconductor device 102 at terminals T7, T1, T5, T6, respectively. Photosensor 54 has a ground terminal (GND) grounded. Capacitor 55 has one electrode connected to terminal T7, and has the other electrode grounded. Capacitor 55 is used to stabilize bias voltage VB.

Photosensor 54 is driven by bias voltage VB and outputs to output terminal (IOUT) current Is of a value corresponding to the illuminance of the location of photosensor 54. Resistive element 52 is connected between terminal T1 and a line of ground voltage GND, and receives current Is output from photosensor 54 and converts the current to voltage Vs.

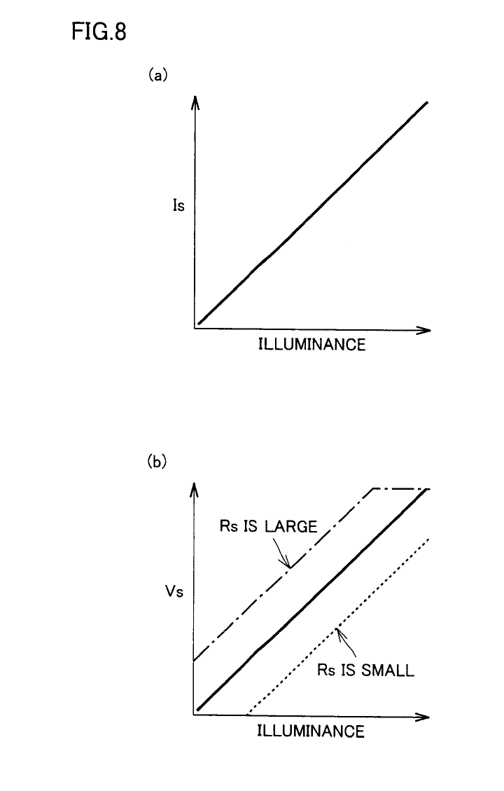

FIG. 8(a) represents a relationship between the illuminance of the location of photosensor 54 and current Is output from photosensor 54, and FIG. 8(b) represents a relationship between the illuminance and voltage Vs of terminal T1. As shown in FIG. 8(a), the level of current Is increases in proportion to the illuminance. Voltage Vs of terminal T1 is a product of current Is and a resistance value Rs of resistive element 52 (Is×Rs). As shown in FIG. 8(b), when resistive element 52 has resistance value Rs set at an appropriate value, voltage Vs increases in proportion to the illuminance. When resistive element 52 has resistance value Rs having an excessively large value, and the illuminance is large, voltage Vs saturates, and the measurement range is narrowed. When resistive element 52 has resistance value Rs having an excessively small value, and the illuminance is small, voltage Vs is 0 V, and the measurement range is narrowed.

Photosensor 54 has a gain (i.e., a ratio of current Is and the illuminance) switched between two levels of high and low by signals GC1, GC2 provided from semiconductor device 102 through terminals T5, T6 to photosensor 54. When signals GC1, GC2 are set to the logic high level and the logic low level, respectively, photosensor 54 has a gain set at a high level, whereas when signals GC1, GC2 are set to the logic low level and the logic high level, respectively, photosensor 54 has a gain set at a low level.

Furthermore, in a fixed gain mode, signals GC1, GC2 have their respective levels fixed regardless of the illuminance. In an automatic gain mode, signals GC1, GC2 have their levels switched in accordance with the illuminance. Register 3 includes a sub register GAIN therein at a predetermined address, and when “1” is written to sub register GAIN, the fixed gain mode is set, whereas when “0” is written to sub register GAIN, the automatic gain mode is set. In the fixed gain mode, the gain of photosensor 54 is manually switchable.

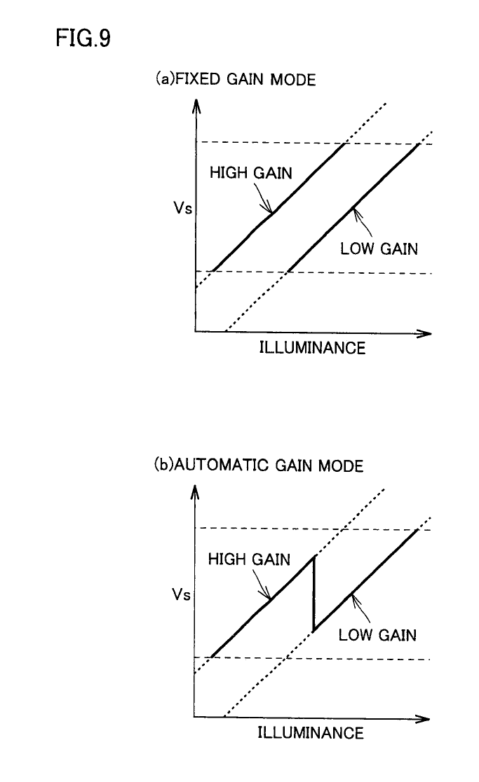

FIG. 9(a) represents a relationship between the illuminance and voltage Vs of terminal T1 in the fixed gain mode and FIG. 9(b) represents a relationship between the illuminance and voltage Vs of terminal T1 in the automatic gain mode. As shown in FIG. 9(a), in the fixed gain mode, the gain is fixed selectively at two levels of high and low. For a single level in illuminance, voltage Vs in a high gain mode is higher than voltage Vs in a low gain mode. Depending on whether the gain is high or low, the measurable illuminance range varies. In the high gain mode, high voltage Vs can be obtained if the illuminance is low. For high illuminance, however, voltage Vs saturates to an upper limit value. In the low gain mode, in contrast, for low illuminance, voltage Vs reaches a lower limit value, however, voltage Vs does not saturate if the illuminance is high.

Furthermore, as shown in FIG. 9(b), in the automatic gain mode, if the illuminance is lower than a threshold value, the gain is increased, and if the illuminance is higher than the threshold value, the gain is decreased. Thus in the automatic gain mode the measurable illuminance range is increased.

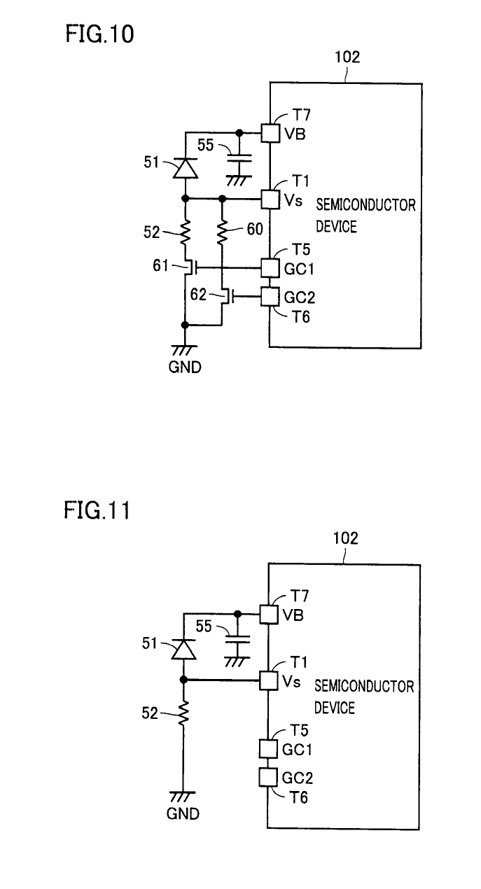

Note that, as shown in FIG. 10, photosensor 54 may be replaced with photodetection element (photodiode) 51, a resistive element 60, and N channel MOS transistors 61, 62. Resistive element 52 and resistive element 60 have resistance value Rs and a resistance value Rss, respectively, having a ratio set for example at 9.5. Photodetection element 51 has a cathode and an anode connected to terminals T7 and T1, respectively. Resistive element 52 and transistor 61 are connected in series between the anode of photodetection element 51 and a line of ground voltage GND. Resistive element 60 and transistor 62 are connected in series between the anode of photodetection element 51 and a line of ground voltage GND. Transistors 61, 62 have their respective gates receiving signals GC1, GC2, respectively.

When signals GC1, GC2 are set to the logic high and low levels, respectively, transistor 61 conducts and transistor 62 does not conduct. Terminal T1 has voltage Vs of a product of current Is output from photodetection element 51 and resistance value Rs of resistive element 52 (Is×Rs), which is a relatively large value. When signals GC1, GC2 are set to the logic low and high levels, respectively, transistor 62 conducts and transistor 61 does not conduct. Terminal T1 has voltage Vs of a product of current Is output from photodetection element 51 and resistance value Rss of resistive element 60 (Is×Rss), which is a relatively small value. Thus the FIG. 10 configuration also allows the gain to be switched between two levels of high and low.

If it is not necessary to switch the gain, then, as shown in FIG. 11, resistive element 60 and transistors 61, 62 may be removed. Resistive element 52 is connected in series between the anode of photodetection element 51 and a line of ground voltage GND. In that case, the gain is fixed at the high level. Furthermore, if resistive element 52 is replaced with resistive element 60, the gain can be fixed at the low level.

Again with reference to FIG. 6, VB generation circuit 7 generates and provides bias voltage VB to terminal T7. VB generation circuit 7 has a normally on mode and an intermittent operation mode. In the normally on mode, VB generation circuit 7 is normally activated to normally generate bias voltage VB. In the intermittent operation mode, VB generation circuit 7 is activated in a set cycle intermittently to generate bias voltage VB intermittently. Register 3 includes a sub register SBIASON therein at a predetermined address, and when “1” is written to sub register SBIASON, the normally on mode is set, whereas when “0” is written to sub register SBIASON, the intermittent operation mode is set. VB generation circuit 7 intermittently operated can contribute to reduced power consumption. Furthermore, when the illuminance is not measured, VB generation circuit 7 is inactivated and terminal T7 is grounded.

A/D converter 8 samples voltage Vs of terminal T1 in a predetermined cycle, and converts the sampled voltage Vs to an 8-bit digital signal. In other words, A/D converter 8 determines which level of voltage of 256 (or 2⁸) levels voltage Vs is, and

A/D converter 8 outputs a digital signal indicating the resultant determination. To achieve reduced power consumption, A/D converter 8 operates intermittently in synchronization with VB generation circuit 7, gain control unit 10 and the like. A/D converter 8 samples voltage Vs 16 times for one operation period and outputs 16 digital signals. When the illuminance is not measured, A/D converter 8 is inactivated and terminal T1 is grounded.

Averaging/brightness determination unit 9 receives the 16 digital signals sequentially output from A/D converter 8 and averages the signals to remove noise and flicker from the signals output from A/D converter 8. Furthermore, averaging/brightness determination unit 9 converts the averaged digital signal to a 4-bit digital signal AMB3-AMB0 (photodetection data DBR) in accordance with gain control. In other words, the averaged digital signal is converted to one of 16 levels of brightness in accordance with gain control.

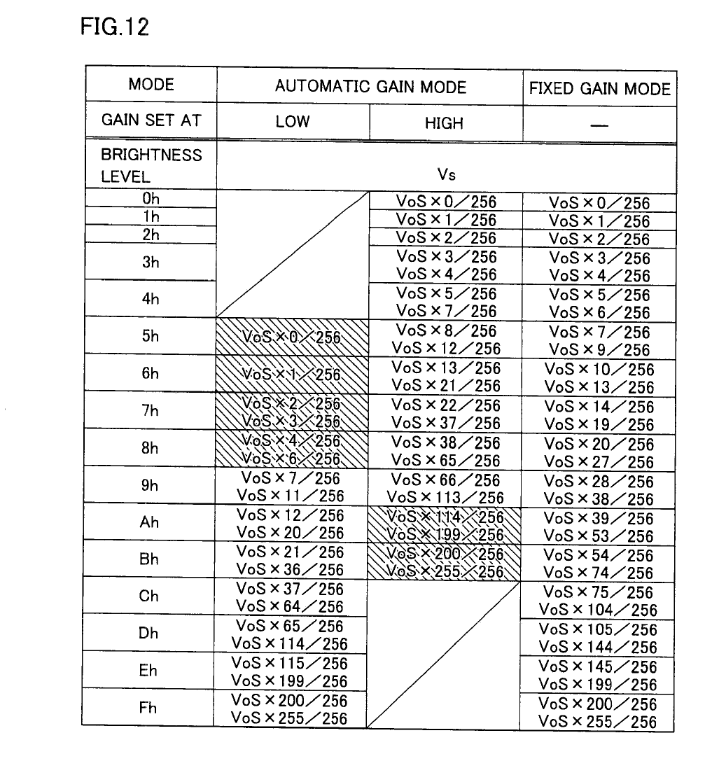

FIG. 12 is a table representing a relationship between voltage Vs of terminal T1 and brightness level. With reference to FIG. 12, it is determined by A/D converter 8 which one of 256 levels in voltage from VoS×0/256 to VoS×255/256 voltage Vs has. In the fixed gain mode, for example if voltage Vs is VoS×0/256, then it is determined that the brightness level is the lowest level, or Oh. In that case, digital signal AMB3-AMB0 is 0000. For example if voltage Vs is VoS×200/256, then it is determined that the brightness level is the highest level, or Fh. In that case, digital signal AMB3-AMB0 is 1111.

Furthermore in the automatic gain mode when the ambient is dark and accordingly the gain is set at the high level, and voltage Vs is for example VoS×0/256, then it is determined that the brightness level is the lowest level, or 0h. In that case, digital signal AMB3-AMB0 is 0000. For example if voltage Vs is VoS×200/256, then it is determined that the brightness level is Bh. In that case, digital signal AMB3-AMB0 is 1011. In other words, while voltage Vs is large, it is determined that the ambient is indeed dark.

Furthermore in the automatic gain mode when the ambient is bright and accordingly the gain is set at the low level, and voltage Vs is for example VoS×0/256, it is determined that the brightness level is 5h. In that case, digital signal AMB3-AMB0 is 0101. In other words, while voltage Vs is small, it is determined that the ambient is indeed bright. Furthermore, for example when voltage Vs is VoS×200/256, it is determined that the brightness level is Fh. In that case, digital signal AMB3-AMB0 is 1111.

Furthermore, in the automatic gain mode, brightness levels Ah-Bh with the gain set at the high level correspond to brightness levels 5h-8h with the gain set at the low level. As such, when mobile phone 202 is moved from a dark place to a bright place, the gain is first in the state of the high level and the brightness level shifts from Ah to Bh, and then the gain shifts to the low level and the brightness level shifts from 5h to 8h. In contrast, when mobile phone 202 is moved from a bright place to a dark place, the gain is first in the state of the low level and the brightness level shifts from 8h to 5h, and then the gain shifts to the high level and the brightness level shifts from Bh to Ah.

Digital signal AMB3-AMB0 indicating brightness level is stored to register 3 at a sub register located at a predetermined address. As such, digital signal AMB3-AMB0 is externally readable. Furthermore, digital signal AMB3-AMB0 is provided to gain control unit 10.

Gain control unit 10 with the fixed gain mode set holds the gain at one of the high and low levels, i.e., a fixed level, regardless of digital signal AMB3-AMB0. Gain control unit 10 with the automatic gain mode set switches the gain from the high level to the low level or vise versa in accordance with digital signal AMB3-AMB0. Furthermore, gain control unit 10 intermittently operates in synchronization with VB generation circuit 7, A/D converter 8 and/or the like to achieve reduced power consumption. When the illuminance is not measured, gain control unit 10 is inactivated and terminals T5, T6 are grounded.

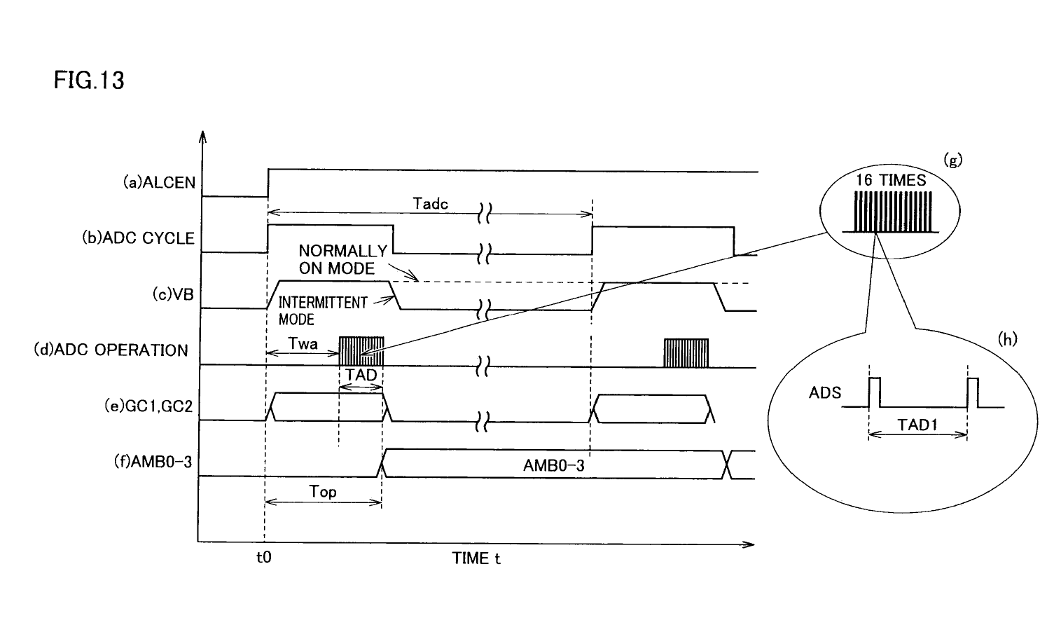

FIGS. 13(a) to 13(h) are timing plots representing how a portion involved in measuring the illuminance operates. As shown in FIG. 13(a), at time t0, “1” (the logic high level) is written to a sub register ALCEN, and in response, measuring the illuminance starts, and VB generation circuit 7, A/D converter 8, averaging/brightness determination unit 9 and gain control unit 10 are activated. As shown in FIG. 13(b), A/D converter 8 operates in a predetermined cycle Tadc intermittently, and operates in each cycle Tadc only for a predetermined operation period Top (e.g., 80.4 ms).

As shown in FIG. 13(c), VB generation circuit 7 with an intermittent mode set operates in synchronization with A/D converter 8 to generate bias voltage VB only for operation period Top of A/D converter 8. VB generation circuit 7 with the normally on mode set normally generates bias voltage VB. Gain control unit 10 operates in synchronization with A/D converter 8 to generate signals GC1, GC2 only for operation period Top of A/D converter 8, as shown in FIG. 13(e).

Furthermore, A/D converter 8 performs an A/D conversion operation 16 times in each operation period Top after a predetermined waiting period Twa (for example of 64 ms), i.e., within an A/D conversion period TAD (for example of 16.4 ms), as shown in FIGS. 13(d), 13(g) and 13(h). In each A/D conversion period TA, an A/D start signal ADS of a predetermined cycle TAD1 (for example of 1.024 ms) is generated, and the A/D conversion is performed in response to each pulse of A/D start signal ADS. Averaging/brightness determination unit 9 receives 16 digital signals output from A/D converter 8 in A/D conversion period TAD and averages the signals to generate a single digital signal and obtains a brightness level in accordance with the digital signal, a set gain and the FIG. 12 table, and outputs 4-bit digital signal AMB3-AMB0 indicating that brightness level.

Again with reference to FIG. 6, averaging/brightness determination unit 9 provides the generated digital signal AMB3-AMB0 (photodetection data DBR) to load current calculation unit 2. Load current calculation unit 2 receives photodetection data DBR, and, as has been described in the first embodiment, generates adjusted current data ITD based on photodetection data DBR, and multiplier parameter STEP, curve setting parameter CRV, minimum load current value IU0 and maximum load current value IU1 provided from register 3, and provides adjusted current data ITD to current supply unit 20.

Current supply unit 20 includes a selector 21, a sloping unit 22, a gate circuit 23, and variable constant current source 4. LED 56 has its anode connected to a line of an external power supply voltage VCC1 and has its cathode connected to terminal T2. Variable constant current source 4 is connected between terminal T2 and a line of ground voltage GND. When variable constant current source 4 has a current passing therethrough, LED 56 emits light at a level in brightness corresponding to current value I of the current. Current value (i.e., load current value) I of variable constant current source 4 is controlled by a signal output from sloping unit 22 and that output from gate circuit 23.

Selector 21 receives adjusted current data ITD generated in load current calculation unit 2, and direct current (dc) current data IMLED6-IMLED0 from register 3. Register 3 has dc current data IMLED6-IMLED0 written in a sub register thereof located at a predetermined address to allow one dc current value to be selected from those of 128 levels. Selector 21 in the automatic light adjustment mode provides adjusted current data ITD to sloping unit 22 and in the register setting mode provides dc current data IMLED6-IMLED0 to sloping unit 22.

Sloping unit 22 has a sloping function to gradually change load current value I to transition the brightness of LED 56 (i.e., the intensity of the light of the backlight of the mobile phone) without making the user of mobile phone 202 feel uncomfortable. Register 3 has rising data TLH3-TLH0 written in a sub register thereof located at a predetermined address to allow load current value I to rise for a variation time TU set at one of 16 levels of time, as desired. Furthermore, register 3 has falling data THL3-THL0 written in a sub register thereof located at a predetermined address to allow load current value I to fall for a variation time TD set at one of 16 levels of time, as desired.

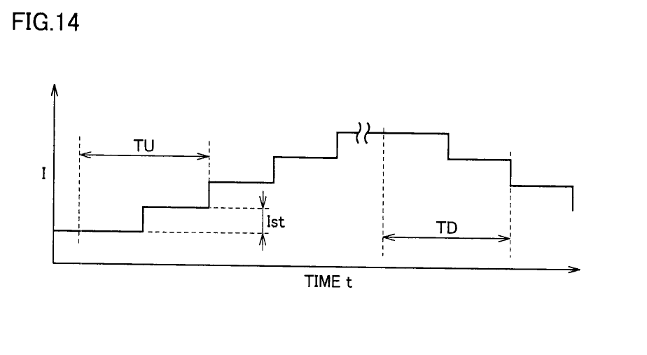

FIG. 14 is a timing plot representing how load current value I varies. In FIG. 14, load current value I varies stepwise by a predetermined step current value Ist. Step current value Ist is a value of 1/256 of a difference of the maximum and minimum values of load current value I. Variation time TU is a period of time required for load current value I to rise by two steps. Variation time TD is a period of time required for load current value I to fall by two steps.

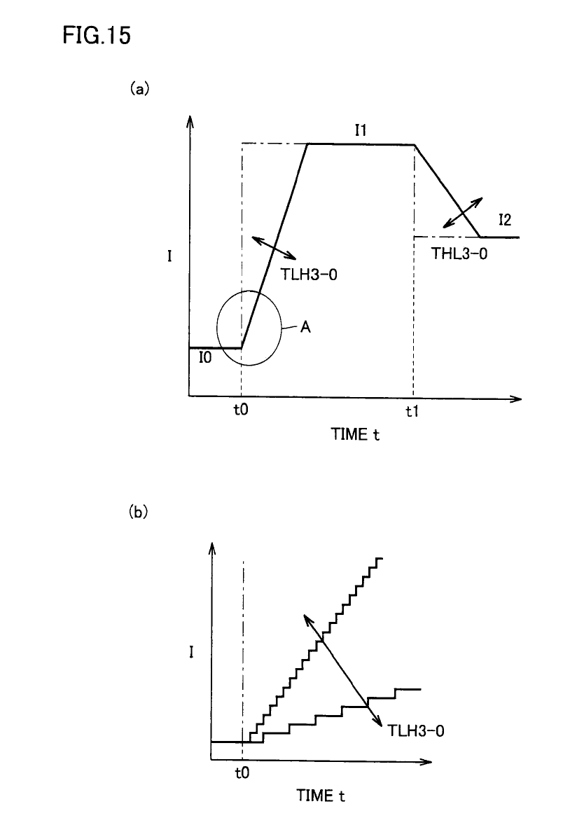

FIG. 15(a) is a timing plot representing how load current value I varies with time in the automatic light adjustment mode and FIG. 15(b) is an enlarged view of a portion A of FIG. 15(a). With reference to FIGS. 15(a) and 15(b), at time t0, adjusted current data ITD indicates that load current value I should be increased from I0 to I1, and in response, sloping unit 22 increases load current value I from I0 to I1 at a rate corresponding to rising data TLH3-TLH0. Then, at time t1, adjusted current data ITD indicates that load current value I should be decreased from I1 to I2, and in response, sloping unit 22 decreases load current value I from I1 to I2 at a rate corresponding to falling data THL3-THL0.

Furthermore, when register 3 has “0” written in a sub register MDCIR thereof located at a predetermined address, sloping unit 22 does not reset load current value I in switching one of the register setting mode and the automatic light adjustment mode to the other of the modes, and gradually changes load current value I. Furthermore, when register 3 has “1” written in sub register MDCIR, sloping unit 22 once resets load current value I to 0 mA in switching one of the register setting mode and the automatic light adjustment mode to the other of the modes, and then gradually increases load current value I from 0 mA.

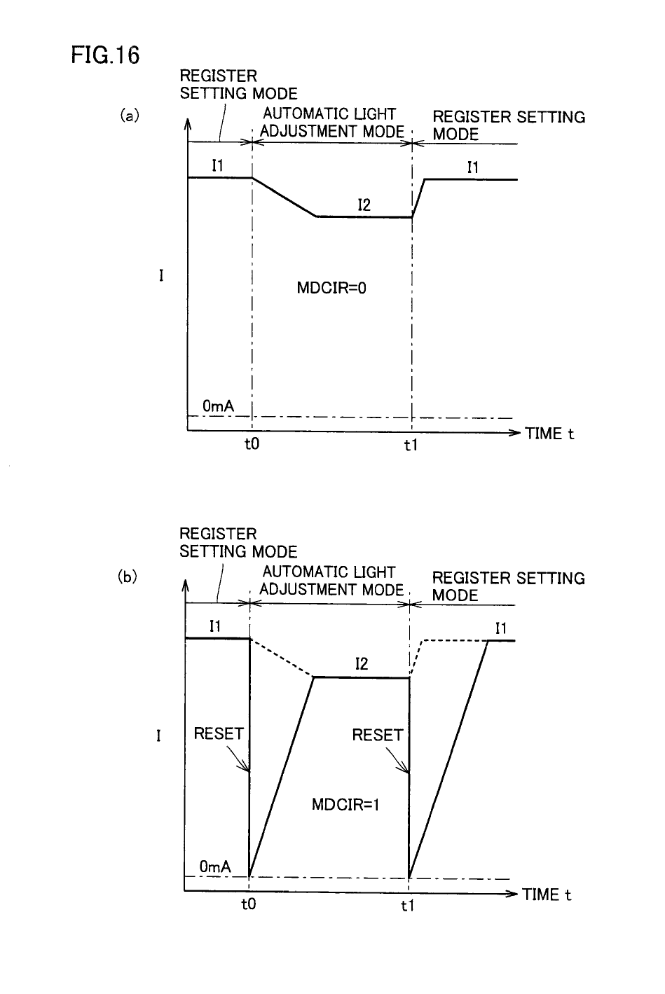

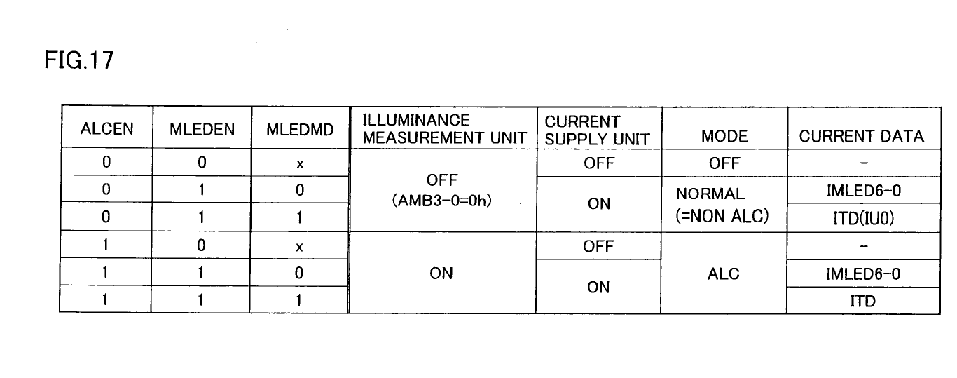

FIGS. 16(a) and 16(b) are timing plots representing how load current value I varies with time for MDCIR=0 and MDCIR=1, respectively. In FIGS. 16(a) and 16(b) is represented an example in which a load current value Il in the register setting mode is larger than a load current value I2 in the automatic light adjustment mode, by way of example.

With reference to FIG. 16(a), for MDCIR=0, at time t0 the register setting mode is shifted to the automatic light adjustment mode, and sloping unit 22 gradually decreases load current value I from I1 to I2 at a rate corresponding to falling data THL3-THL0. Then at time t1 the automatic light adjustment mode is shifted to the register setting mode, and sloping unit 22 gradually increases load current value I from I2 to I1 at a rate corresponding to rising data TLH3-TLH0. When one of the register setting mode and the automatic light adjustment mode is shifted to the other, load current value I (i.e., the backlight's brightness) can be changed smoothly.

With reference to FIG. 16(b), for MDCIR=1, at time t0 the register setting mode is shifted to the automatic light adjustment mode, and sloping unit 22 once resets load current value I to 0 mA and then gradually increases load current value I from 0 mA to I2 at a rate corresponding to rising data TLH3-TLH0. Then at time t1 the automatic light adjustment mode is shifted to the register setting mode, and sloping unit 22 once resets load current value I to 0 mA and then increases load current value I from 0 mA to I1 at a rate corresponding to rising data TLH3-TLH0. Thus, when one of the register setting mode and the automatic light adjustment mode is shifted to the other, load current value I (i.e., the backlight's brightness) can once be set to zero to clearly inform the user that a mode has been shifted.

Again with reference to FIG. 6, gate circuit 23 receives a pulse width modulation (PWM) signal from microcomputer 58 through terminal T8. Register 3 includes a sub register WPWMEN therein at a predetermined address, and when “0” is written to sub register WPWMEN, gate circuit 23 outputs a signal having the logic high level regardless of the PWM signal. In that case, variable constant current source 4 passes a current of a level corresponding to a signal output from sloping unit 22.

In contrast, when “1” is written to sub register WPWMEN, the PWM signal passes through gate circuit 23 and is provided to variable constant current source 4. While the PWM signal has the logic high level, variable constant current source 4 passes a current of a level corresponding to a signal output from sloping unit 22. While the PWM signal has the logic low level, variable constant current source 4 does not pass a current. As such, setting WPWMEN=1 allows PWM control based on a signal output from sloping unit 22.

FIG. 17 is a table representing a relationship between data written in sub registers ALCEN, MLEDEN, MLEDMD and how semiconductor device 102 operates. In FIG. 17, when sub register ALCEN has 0 written therein, the illuminance measurement unit (VB generation circuit 7, A/D converter 8, averaging/brightness determination unit 9, and gain control unit 10) is inactivated (or turned off), and when sub register ALCEN has 1 written therein, the illuminance measurement unit (circuits 7-10) is activated (or turned on).

Furthermore, when sub register MLEDEN has 0 written therein, current supply unit 20 is inactivated, and when sub register MLEDEN has 1 written therein, current supply unit 20 is activated. Furthermore, when sub register MLEDMD has 0 written therein, selector 21 selects dc current data IMLED6-IMLED0, and when sub register MLEDMD has 1 written therein, selector 21 selects adjusted current data ITD.

As shown in FIG. 17 at the top row, when sub registers ALCEN and MLEDEN have 00, respectively, written therein, the illuminance measurement unit (circuits 7-10) and current supply unit 20 are inactivated regardless of the data of sub register MLEDMD, and no current data is generated. Reduced power consumption can thus be achieved.

As shown in FIG. 17 at the second row, when sub registers ALCEN, MLEDEN, MLEDMD have 010, respectively, written therein, the illuminance measurement unit (circuits 7-10) is inactivated and current supply unit 20 is activated, and dc current data IMLED6-IMLED0 is selected. This allows the backlight to be held at a constant brightness level regardless of the illuminance.

As shown in FIG. 17 at the third row, when sub registers ALCEN, MLEDEN, MLEDMD have 011, respectively, written therein, the illuminance measurement unit (circuits 7-10) is inactivated and current supply unit 20 is activated, and adjusted current data ITD is selected. In that case, load current value I is minimum value IU0. Reduced power consumption can thus be achieved.

As shown in FIG. 17 at the fourth row, when sub registers ALCEN, MLEDEN have 10, respectively, written therein, the illuminance measurement unit (circuits 7-10) is activated and current supply unit 20 is inactivated regardless of the data of sub register MLEDMD, and no current data is generated. In that case, brightness data is utilized without driving the backlight.

As shown in FIG. 17 at the fifth row, when sub registers ALCEN, MLEDEN, MLEDMD have 110, respectively, written therein, the illuminance measurement unit (circuits 7-10) and current supply unit 20 are both activated and dc current data IMLED6-IMLED0 is selected. This allows the backlight to be held at a constant brightness level regardless of the illuminance.

As shown in FIG. 17 at the bottom row, when sub registers ALCEN, MLEDEN, MLEDMD have 111, respectively, written therein, the illuminance measurement unit (circuits 7-10) and current supply unit 20 are both activated and adjusted current data ITD is selected. In that case, the automatic light adjustment (ALC) mode is set.

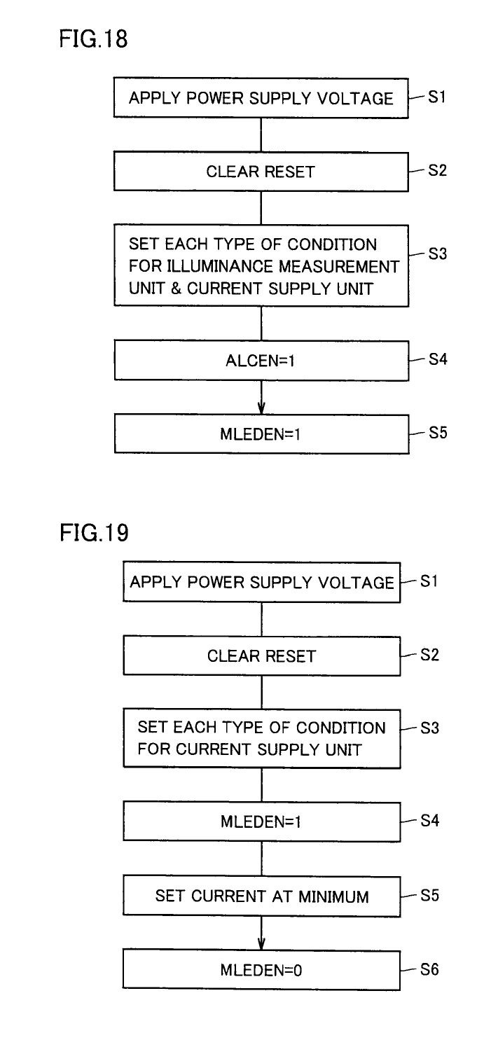

FIG. 18 is a flowchart representing a method of turning on the backlight (LED 56) in the automatic light adjustment mode. With reference to FIG. 18, step S1 is performed to apply power supply voltage to semiconductor device 102, and step S2 is performed to clear resetting of semiconductor device 102, and step S3 is performed to set each type of condition for each of the illuminance measurement unit (circuits 7-10) and current supply unit 20. Then, step S4 is performed to write “1” to sub register ALCEN, and after waiting by waiting period Twa as shown in FIG. 13, step S5 is performed to write “1” to sub register MLEDEN. Thus, LED 56 emits light at a brightness level corresponding to the illuminance. To turn off LED 56, “0” is written to sub register MLEDEN.

FIG. 19 is a flowchart representing a method of turning on and off the backlight (LED 56) in the register setting mode. With reference to FIG. 19, step S1 is performed to apply power supply voltage to semiconductor device 102, and step S2 is performed to clear resetting of semiconductor device 102, and step S3 is performed to set each type of condition, such as a sloping time of current supply unit 20, and step S4 is performed to write “1” to sub register MLEDEN. Thus load current value I rises in accordance with the set sloping time and LED 56 turns on. Step S5 is performed to set a dc current value at a minimum value, and accordingly, load current value I falls in accordance with the set sloping time and LED 56 is decreased in brightness. Step S6 is performed to write “0” to sub register MLEDEN, and accordingly, LED 56 turns off instantaneously.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### DESCRIPTION OF THE REFERENCE SIGNS

1, 8: A/D converter; 2: load current calculation unit; 3: register; 4: variable constant current source; 5: data generation unit; 6: signal I/O circuit; 7: VB generation circuit; 9: averaging/brightness determination unit; 10: gain control unit; 11: table unit; 12: current adjustment unit; 20: current supply unit; 21: selector; 22: sloping unit; 23: gate circuit; 51: photodetection element; 52, 60: resistive element; 53: load; 54: photosensor; 55: capacitor; 57: operation unit; 58: microcomputer; 61, 62: N channel MOS transistor; 101, 102: semiconductor device; 201: electronics; 202: mobile phone; T1-T8: terminal.

1. A semiconductor device comprising:
a table unit for receiving photodetection data indicating an intensity of light, and outputting current data indicating a current value corresponding to a value of said photodetection data, said table unit having an association between said photodetection data and said current data stored therein in a fixed manner;
a current adjustment unit for adjusting said current value indicated by said current data in accordance with a variable parameter, and outputting adjusted current data indicating said current value adjusted; and
a current supply unit for supplying a load with a current based on said adjusted current data.

2. The semiconductor device according to claim 1, wherein:
said current adjustment unit adjusts said current value indicated by said current data in accordance with first to third variable parameters, and outputs said adjusted current data indicating said current value adjusted;
said first parameter indicates a value for multiplying said current value indicated by said current data;
said second parameter indicates a minimum value of said current to be supplied to said load;
said third parameter indicates a maximum value of said current to be supplied to said load; and
said current adjustment unit outputs said adjusted current data indicating a product of said current value indicated by said current data and said value indicated by said first parameter plus said minimum value indicated by said second parameter, and if said adjusted current data indicates a current value larger than said maximum value indicated by said third parameter, said current adjustment unit outputs adjusted current data indicating said maximum value.

3. The semiconductor device according to claim 2, wherein:
said table unit has a plurality of types of associations between said photodetection data and said current data stored therein in a fixed manner;
said parameter indicates what type of association said photodetection data and said current data have therebetween; and
said table unit outputs said current data indicating said current value corresponding to said value of said photodetection data in accordance with said parameter.

4. The semiconductor device according to claim 1, wherein:
said parameter indicates a value for multiplying said current value indicated by said current data; and
said current adjustment unit outputs adjusted current data indicating a product of said current value indicated by said current data and said value indicated by said parameter.

5. The semiconductor device according to claim 1, wherein:
said parameter indicates a minimum value of said current to be supplied to said load; and
said current adjustment unit outputs adjusted current data indicating a sum of said current value indicated by said current data and said minimum value indicated by said parameter.

6. The semiconductor device according to claim 1, wherein:
said parameter indicates a maximum value of said current to be supplied to said load; and
if said current data indicates a current value larger than said maximum value indicated by said parameter, said current adjustment unit outputs adjusted current data indicating said maximum value.

7. The semiconductor device according to claim 1, wherein:
said table unit has a plurality of types of associations between said photodetection data and said current data stored therein in a fixed manner;
said parameter indicates what type of association said photodetection data and said current data have therebetween; and
said table unit outputs said current data indicating said current value corresponding to said value of said photodetection data in accordance with said parameter.

8. The semiconductor device according to claim 1, further comprising:
a register for storing said photodetection data and said parameter; and
a signal input/output circuit for externally outputting said photodetection data stored in said register, and for externally receiving said parameter and providing said parameter to said register.

9. The semiconductor device according to claim 1, further comprising:
a voltage generation circuit for supplying an external photosensor with power supply voltage; and
a data generation unit for generating said photodetection data in accordance with a current output from said photosensor.

10. The semiconductor device according to claim 9, further comprising a gain control unit for controlling a gain of said photosensor in accordance with said photodetection data, wherein said data generation unit generates said photodetection data in accordance with said gain of said photosensor and said current output from said photosensor.

11. The semiconductor device according to claim 10, wherein said voltage generation circuit, said data generation unit and said gain control unit operate in a predetermined cycle intermittently.

12. The semiconductor device according to claim 1, further comprising:
an A/D converter for converting an analog voltage indicating an intensity of light to a digital signal in a predetermined first cycle; and
an averaging unit for averaging a plurality of digital signals generated in said A/D converter to generate said photodetection data.

13. The semiconductor device according to claim 12, wherein:
said A/D converter operates in a second cycle intermittently to generate said plurality of digital signals in each operation period, said second cycle being longer than said first cycle; and
said averaging unit averages said plurality of digital signals to generate said photodetection data whenever said A/D converter generates said plurality of digital signals.

14. The semiconductor device according to claim 1, wherein when said adjusted current data indicates that said current value adjusted has transitioned from a first current value to a second current value, said current supply unit gradually varies said current to be supplied to said load from said first current value to said second current value.

15. The semiconductor device according to claim 14, wherein a rate used to vary a value of said current to be supplied to said load is settable to a desired value.

16. The semiconductor device according to claim 1, wherein said current supply unit supplies said load with said current in accordance with said adjusted current data when a PWM signal has a first logic level, and said current supply unit stops supplying said load with said current when said PWM signal has a second logic level.

17. Electronics comprising:
a photosensor for outputting a current corresponding to an intensity of light incident thereon;
a light emitting element;
a data generation unit for outputting photodetection data based on said current output from said photosensor, and indicating said intensity of light incident on said photosensor;
a table unit for receiving said photodetection data and outputting current data indicating a current value corresponding to a value of said photodetection data, said table unit having an association between said photodetection data and said current data stored therein in a fixed manner;
a current adjustment unit for adjusting said current value indicated by said current data in accordance with a variable parameter, and outputting adjusted current data indicating said current value adjusted; and
a current supply unit for supplying said light emitting element with a current based on said adjusted current data.
